(19) United States
(12) Patent Application Publication
(10) Pub. No.: US 2011/0304659 A1
(43) Pub. Date: Dec. 15, 2011

(54) DLP PROJECTOR AND COLOR COMPENSATION METHOD OF BULB OF DLP PROJECTOR

(75) Inventors: Jian-Wei Lee, Taipei Hsien (TW); Hsin-Yu Chen, Taipei Hsien (TW)

(73) Assignee: ACER INCORPORATED, Taipei Hsien (TW)

(21) Appl. No.: 12/851,549

(22) Filed: Aug. 5, 2010

(30) Foreign Application Priority Data
Jun. 15, 2010 (TW) 99119559

(51) Int. Cl. G09G 5/02; G03B 21/14

(52) U.S. Cl. 345/694; 353/121; 353/84

(57) ABSTRACT

A digital light processing (DLP) projector and a color compensation method of a bulb of the DLP projector are provided. The DLP projector comprises a projecting unit, a sensing unit and a color compensation unit. The projecting unit comprises a bulb, a color wheel and a control module. The control module controls the energy provided for the bulb and the color of the color wheel according to an energy waveform so as to enable the projecting unit to project a plurality of color lights. The sensing unit detects the quality of the color lights projected by the projecting unit. The color compensation unit calculates a difference between the quality detected by the sensing unit and the original quality of each of the color lights, and adjusts the energy waveform accordingly, so as to compensate the difference of each of the color lights.

### CROSS-REFERENCE TO RELATED APPLICATION

This application claims the priority benefit of Taiwan application serial no. 99119559, filed on Jun. 15, 2010. The entirety of the above-mentioned patent application is hereby incorporated by reference herein and made a part of this specification.

### BACKGROUND OF THE INVENTION

1. Field of the Invention

This invention is related to a DLP projector and a color compensation method of a bulb of the DLP projector.

2. Description of Related Art

With advancement in projection display technology, there have been rapid development and significant breakthroughs in projection systems and equipments in recent years. The operating principle of a projector is similar to that of a transparency or a slide, which uses a high-luminance lamp as a light source and projects a frame onto a white screen or a wall. Based on the technical principle, the ordinary projectors in current market include high-temperature polysilicon (HTPS) liquid crystal display (LCD) projectors and digital light processing (DLP) projectors. The technical principle of the DLP projector is to use a rotating color wheel to split a light of a light source into a red light, a green light and a blue light, and then project these color lights onto a screen through a reflection of a digital micromirror device (DMD), so as to present a color projection frame.

Since the materials adopted by the DLP projector are all inorganic, the DLP projector has fine projection quality even being exposed to a heat source or a light source for a long time. On the other hand, the materials adopted by the LCD projector are organic, such that the LCD projector is easily influenced by the temperature and humidity in nearby environment and defects are often occurred in the projection frames thereof.

Although the inorganic materials adopted by the DLP projector are not easily gone bad under the influence of the environment, the aging of the bulb of the DLP projector still influences the quality of the projection frames, and the phenomena such as luminance attenuation and color unbalance (e.g. frame biased to yellow) are possibly occurred. The lifespan of an ordinary bulb is about 4000 or more hours, however, a color bias phenomenon of the bulb can be clearly observed not until the time claimed by the specification. Since the bulb is expensive, frequently replacing the bulb will greatly increase the use cost of the DLP projector. Therefore, how to extend the lifetime of the bulb of the DLP projector without affecting the quality of its projection frames has become a major issue in the related filed.

### SUMMARY OF THE INVENTION

In light of the above, the present invention provides a DLP projector and a color compensation method of a bulb of the DLP projector, which can perform color compensation on the DLP projector when the bulb of the DLP projector ages, so as to resume a color balance of the projection frames thereof.

The present invention provides a color compensation method of a projector bulb, suitable for a DLP projector having a bulb and a color wheel. In the present method, a plurality of color lights are projected according to an energy waveform, which defines the energy provided for the bulb when the DLP projector projects each of the color lights. Next, a quality of each of the color lights projected by the DLP projector is detected. Finally, a difference between the detected quality and an original quality of each of the color lights is calculated, so as to adjust the energy waveform and compensate the difference of each of the color lights.

The present invention provides a color compensation method of a projector bulb, suitable for a DLP projector having a bulb and a color wheel. In the present method, at least one test frame is projected according to an energy waveform, which defines the energy provided for the bulb when the DLP projector projects one of a plurality of color lights. Next, a quality of each of the color lights projected by the DLP projector is detected. Finally, a difference between the detected quality and an original quality of each of the color lights is calculated, so as to adjust the energy waveform and compensate the difference of each of the color lights.

The present invention provides a color compensation method of a projector bulb, suitable for a DLP projector having a bulb and a color wheel. In the present method, a plurality of color lights are projected according to an energy waveform, which defines the energy provided for the bulb when the DLP projector projects each of the color lights. Next, a quality of each of the color lights projected by the DLP projector is detected. Finally, a difference between the detected quality and an original quality of each of the color lights is calculated, so as to select the energy waveform suitable for compensating the difference of each of the color lights from a plurality of energy waveforms and provide the selected energy waveform for the DLP projector to implement.

The present invention provides a DLP projector comprising a projecting unit, a sensing unit and a color compensation unit. The projecting unit comprising a bulb, a color wheel and a control module. The control module controls an energy provided for the bulb and a color of the color wheel according to an energy waveform so as to enable the projecting unit to project a plurality of color lights, wherein the energy waveform defines the energy provided for the bulb when the DLP projector projects each of the color lights. The sensing unit detects a quality of each of the color lights projected by the DLP projector. The color compensation unit calculates a difference between the detected quality and an original quality of each of the color lights, so as to adjust the energy waveform and compensate the difference of each of the color lights.

Based on the above, the present invention adjusts the energy waveform defined for the bulb of the DLP projector by detecting the color lights projected by the DLP projector, so as to perform color compensation on the projection frame of the DLP projector to return to a color balance when the bulb of the DLP projector ages.

In order to make the aforementioned and other features and advantages of the invention more comprehensible, embodiments accompanying figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram of a DLP projector according to an embodiment of the present invention.

FIG. 2 is a flowchart illustrating a color compensating method of a projector bulb according to an embodiment of the present invention.

FIG. 3 is a schematic diagram of an energy waveform according to an embodiment of the present invention.

FIG. 4 is a block diagram of a DLP projector according to an embodiment of the present invention.

FIG. 5 is a flowchart illustrating a color compensating method of a projector bulb according to an embodiment of the present invention.

FIG. 6 is a flowchart illustrating a color compensating method of a projector bulb according to an embodiment of the present invention.

FIG. 7 is a flowchart illustrating a color compensating method of a projector bulb according to an embodiment of the present invention.

FIG. 8 is a flowchart illustrating a color compensating method of a projector bulb according to an embodiment of the present invention.

FIGS. 9A to 9C are schematic diagrams of energy waveforms according to an embodiment of the present invention.

FIG. 10 is a schematic diagram of an energy waveform according to an embodiment of the present invention.

### DESCRIPTION OF EMBODIMENTS

To provide better view quality for users, the present invention detects a quality of each of the color lights projected by a DLP projector and accordingly adjusts an energy waveform defining an energy provided for the bulb of the DLP projector, so as to make the quality of color lights received by a color sensor be close to the quality of the original color light. The quality of color light comprises brightness, hues, saturation, and spectrum. In order to make the invention more comprehensible, embodiments are described below as the examples to prove that the invention can actually be realized.

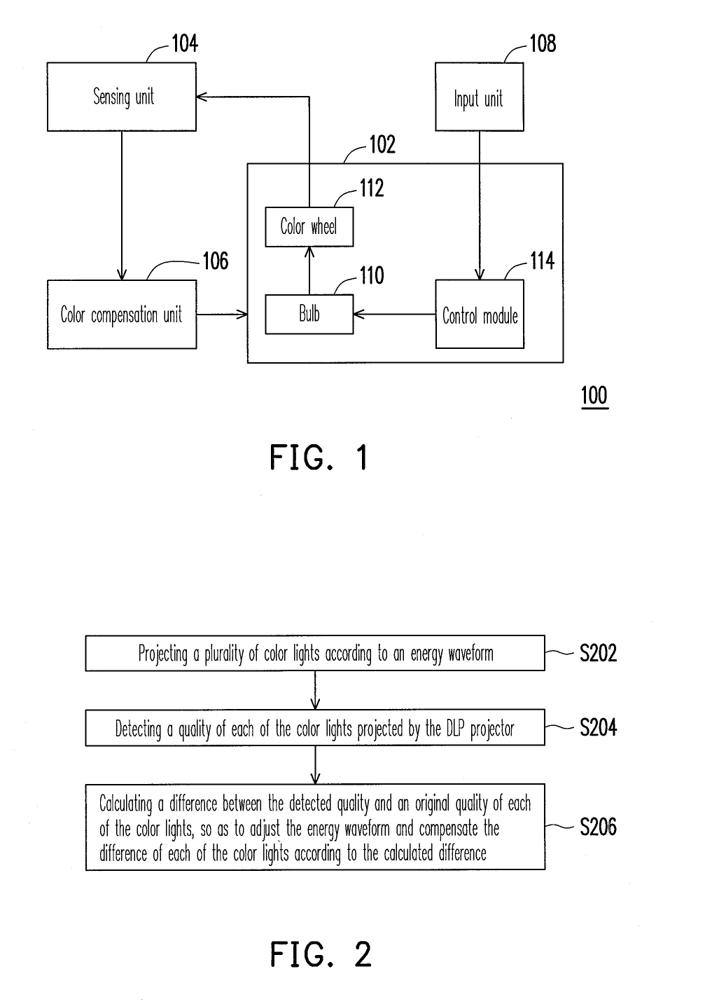

FIG. 1 is a block diagram of a DLP projector according to an embodiment of the present invention. Referring to FIG. 1, a DLP projector of the present invention comprises a projecting unit 102, a sensing unit 104, a color compensation unit 106 and an input unit 108. The projecting unit 102 comprises a bulb 110, a color wheel 112 and a control module 114. The controller 114 is, for example, a ballaster, and is coupled to the input unit 108 and the bulb 110. The control module 114 receives image data inputted by the input unit 108 and lights up the bulb 110 according to the energy waveform, so as to enable the projecting unit 102 to project the frames of the image data.

The projecting unit 102 and the sensing unit 104 may be respectively disposed at locations with different distances from the user, so as to execute the projection and light sensing function at these locations. The sensing unit 104 may be disposed at the location closer to the user. For example, the sensing unit 104 may be disposed on the remote controller by the side of the user or disposed on an object placed at a specific location around the user, so as to detect the color light around the user reflected by the projection frame of the projecting unit 102. As such, the color light detected by the sensing unit 104 may be closer to the real feeling of user's eyes.

In addition, the color compensation unit 106 calculates a difference between the quality detected by the sensing unit 104 and an original quality of the color light, and accordingly adjusts the energy waveform and changes the energy provided for the bulb 110, so as to compensate the phenomena such as luminance attenuation or color unbalance of the projection frame resulting from the aging of the bulb 110.

In detail, FIG. 2 is a flowchart illustrating a color compensating method of a projector bulb according to an embodiment of the present invention. Referring to FIG. 1 and FIG. 2, the present embodiment is suitable for the DLP projector 100 of FIG. 1, and is used for compensating the luminance attenuation or color unbalance of the projected color lights resulting from the aging of the bulb 110. The detailed steps are as follows.

First, the projecting unit 102 projects a plurality of color lights according to an energy waveform (step S202), in which the energy waveform defines an energy provided for the bulb 110 when the projecting unit 114 projects each of the color lights.

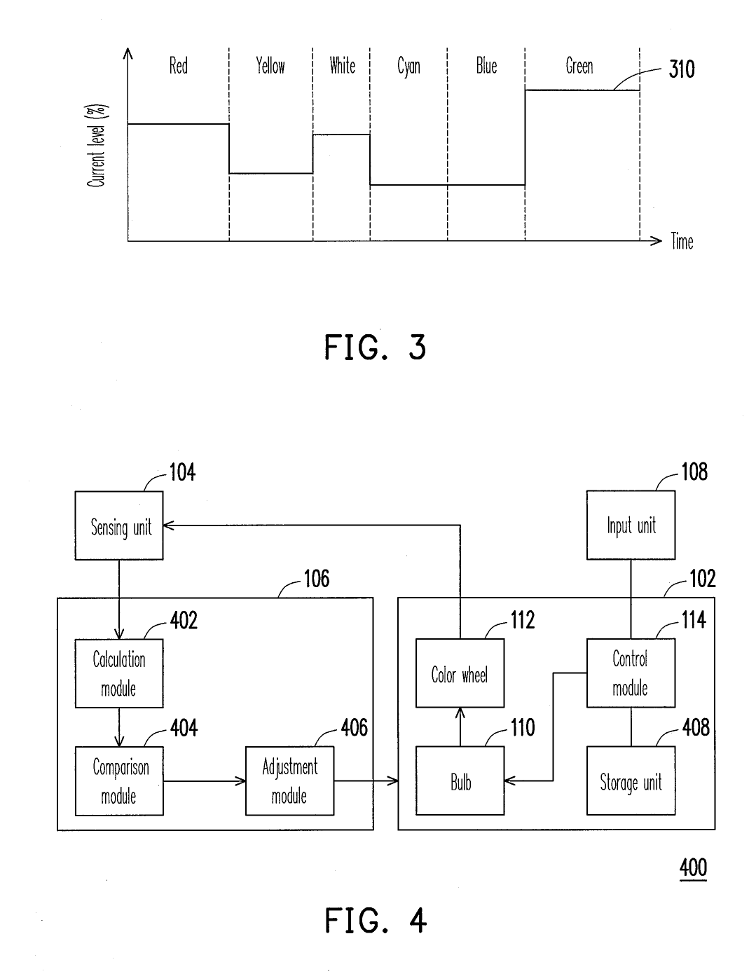

For example, FIG. 3 is a schematic diagram of a waveform according to an embodiment of the present invention. Referring to FIG. 3, the six colors arranged on the energy waveform 300 of the present embodiment are corresponding to different color areas of the color wheel 112. The wave line 310 drawn in FIG. 3 represents the energy (e.g. current level) received by the bulb 110 when the color wheel 112 is rotated to different color areas. In the present embodiment, it is assumed that there are red, yellow, white, cyan, blue and green colors sequentially arranged on the color wheel 112. When the color wheel 112 is rotated, the DLP projector 400 adjusts the energy provided for the bulb 110 in accordance with the rotation of the color wheel 112, so as to emit lights with different strengths. When the light emitted by the bulb 110 passes an area of certain color on the color wheel 112, the lights of other colors are filtered out, such that the light passing through the color wheel 112 is transformed into the color light corresponding to the color of the area. For example, when the color 112 is rotated to a yellow area, the light emitted by the bulb 110 is transformed into a yellow light after passing through the color wheel 112. It is noted herein that the luminance of each of the color lights is proportional to the strength of the light emitted by the bulb 110, that is, the energy received by the bulb 110. When the current level provided for the bulb 110 is higher, the strength of the light emitted by the bulb 110 is stronger and the luminance of the color light is higher. On the contrary, when the current level provided for the bulb 110 is lower, the strength of the light emitted by the bulb 110 is weaker and the luminance of the color light is lower.

Back to FIG. 2, the sensing unit 104 then detects a quality of each of the color lights projected by the DLP projector (step S204). In detail, the sensing unit 104 detects corresponding color light according to an arrangement and a ratio of the areas with different colors of the color wheel 112. For example, when the color 112 is rotated to a green area to enable the projecting unit 102 to emit a green light, the sensing unit 104 detects the quality of the green light.

Then, the color compensation unit 106 calculates a difference between the quality detected by the sensing unit 104 and an original quality of each of the color lights, so as to compensate the difference of each of the color light resulting from the aging of the bulb 110 (step S206).

It is noted herein that aforesaid color compensation unit 106 may be classified into a plurality of elements, so as to implement various adjusting mechanisms. FIG. 4 is a block diagram of a DLP projector according to an embodiment of the present invention. Referring to FIG. 4, in the DLP projector 400 of the present embodiment, the color compensation unit 106 is further divided into a calculation module 402, a comparison module 404 and an adjustment module 406. The calculation module 402 calculates a difference between a quality of the color light detected by the sensing unit 104 and an original quality of the color light. The comparison module 404 determines whether to perform an adjustment on the color light according to degree of the quality difference of the color light calculated by the calculation module 402. The adjustment module 406 adjusts the energy waveform to compensate the difference of the color light when the comparison module 404 determines to perform the adjustment on the color light.

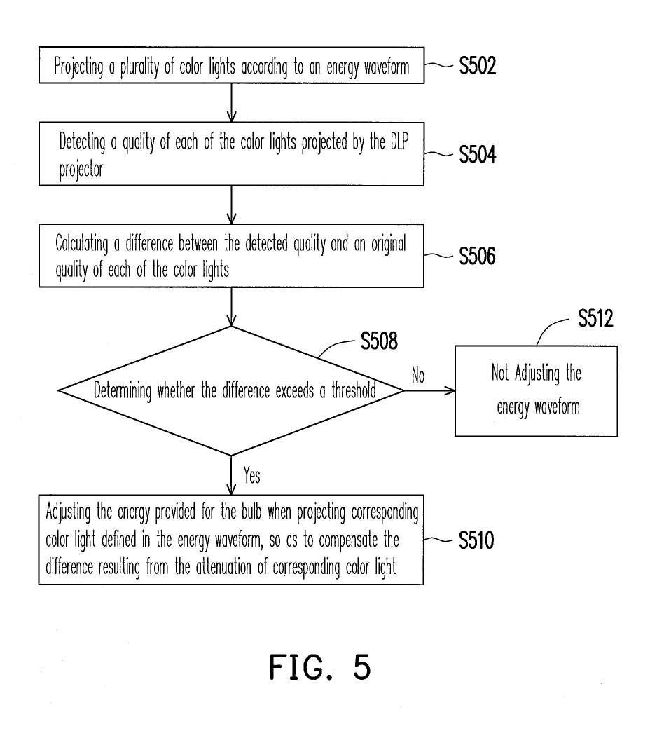

In detail, FIG. 5 is a flowchart illustrating a color compensating method of a projector bulb according to an embodiment of the present invention. Referring to FIG. 4 and FIG. 5, the color compensating method of the present embodiment is suitable for the DLP projector 400 of FIG. 4, and is used for compensating the luminance attenuation or color unbalance of the projected color lights resulting from the aging of the bulb 110. The detailed steps are as follows.

First, the projecting unit 102 projects a plurality of color lights according to an energy waveform (step S502), in which the energy waveform defines an energy provided for the bulb 110 when the projecting unit 114 projects each of the color lights. Next, the sensing unit 104 detects a quality of each of the color lights projected by the DLP projector 400 (step S504). Then, the calculation module 402 calculates a difference between a quality detected by the sensing unit 104 and an original quality of each of the color lights (step S506). Next, the comparison module 404 determines whether the difference between the detected quality and corresponding original quality of the color light calculated by the calculation module 402 exceeds a threshold (step S508). If the difference between the detected quality and the original quality of the color light exceeds the threshold, the adjustment module 406 adjusts the energy provided for the bulb 110 when projecting corresponding color light defined in the energy waveform, so as to compensate the difference resulting from the attenuation of the corresponding color light (step S510). If the difference between the detected quality and the original quality of the color light does not exceed the threshold, the adjustment module 406 does not adjust the energy waveform (step S512).

For example, it is assumed that an original luminance of a blue light is 2000 ANSI and a threshold of the luminance of the blue light is 200 ANSI. When the comparison module 404 determines the luminance difference of the blue light is higher than 200 ANSI (i.e. the luminance of the blue light detected by the sensing unit 104 is lower than 1800 ANSI), the adjustment module 406 increases the current level corresponding to the blue light in the energy waveform, so as to recover the luminance of the blue light back to the original 2000 ANSI and compensate the attenuation of the blue light resulting from the aging of the bulb 110. On the contrary, when the comparison module 404 determines the luminance difference of the blue light is lower than 200 ANSI (i.e. the luminance of the blue light detected by the sensing unit 104 is higher than 1800 ANSI), it represents the luminance attenuation of the blue light is acceptable so that the adjustment module 406 does not adjust the energy waveform.

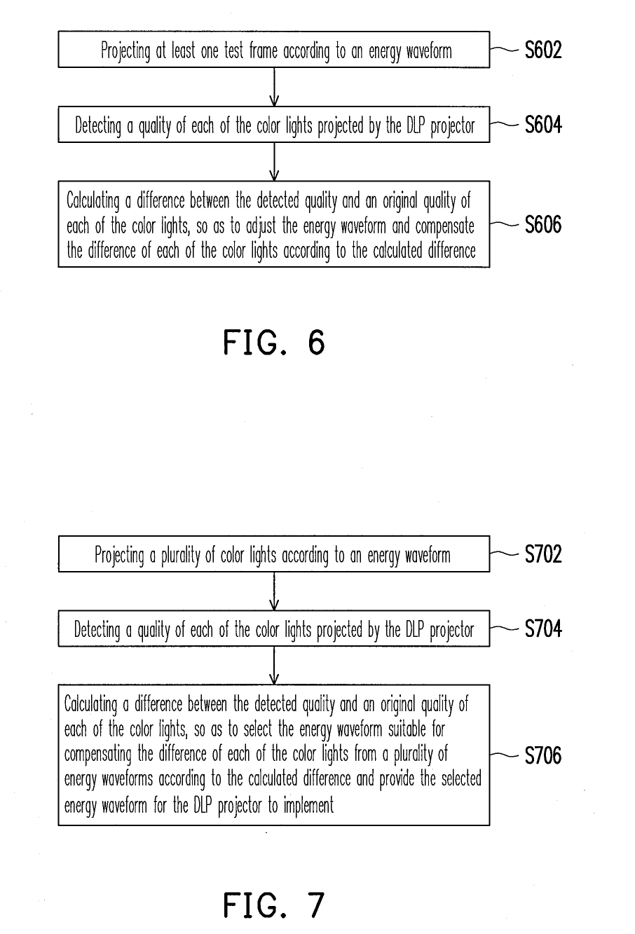

FIG. 6 is a flowchart illustrating a color compensating method of a projector bulb according to an embodiment of the present invention. Referring to FIG. 4 and FIG. 6, the color compensating method of the present embodiment is different from that of FIG. 2 on that the present embodiment adjusts the energy waveform through the projecting unit 102 projecting test frames. The detailed steps are as follows.

First, the projecting unit 102 projects at least one frame according to the energy waveform (step S602). Next, the sensing unit 104 detects a quality of each of the color lights projected by the DLP projector 400 (step S604).

In detail, if the sensing unit 104 in the step S604 is a photo sensor, since the photo sensor can only detect color light in fixed frequency domain, in the step S602, the projecting unit 102 is required to repeatedly project a plurality of test frames, so as to detect the quality of each of the color lights. For example, if the color wheel 112 comprises a red area, a green area and a blue area, the projecting unit 102 is able to project red, blue and green test frames and the photo sensor is able to sequentially detect the quality of the three color lights. Furthermore, in another embodiment, the sensing unit 104 can be a color sensor. Since the color sensor itself can identify color lights in different frequency domains, in the step S602, the projecting unit 102 is required to only project a white frame. As such, the color sensor is able to identify the quality of each of the color lights in the step S604.

After the quality of each of the color lights is detected, the color compensation unit 106 calculates a difference between the quality detected by the sensing unit 104 and an original quality of each of the color lights, so as to adjust the energy waveform according to the difference and compensate the difference of each of the color lights (step S606). This step is similar to aforesaid step S206, such that the detailed description is omitted herein.

FIG. 7 is a flowchart illustrating a color compensating method of a projector bulb according to an embodiment of the present invention. Referring to FIG. 4 and FIG. 7, the color compensating method of the present embodiment is different from that of FIG. 2 on that, when performing the adjustment on the energy waveform, the present embodiment selects the energy waveform most suitable for compensating the attenuation of each of the color lights from a plurality of waveforms, so as to improve the quality of the color lights. The detailed steps are as follows.

First, the projecting unit 102 projects a plurality of color lights according to the energy waveform (step S702). Next, the sensing unit 104 detects a quality of each of the color lights projected by the DLP projector 400 (step S704).

Then, the color compensation unit 106 calculates a difference between the quality detected by the sensing unit 104 and an original quality of each of the color lights, so as to select the energy waveform suitable for compensating the difference of each of the color lights from a plurality of energy waveforms and provide the selected energy waveform for the DLP projector 400 to implement (step S706). In detail, since the color light detected by the sensing may be a direct light directly projected by the DLP projector 400, or a reflection light reflected by a projection frame of the DLP projector 400, it is necessary to provide different criteria for determining the level of the attenuation of the color lights under aforesaid two situations. In addition, the aging of the bulb 110 may cause attenuation on more than one color lights. In order to compensate the color light having most attenuation without affecting a color balance, it is necessary to provide a plurality of energy waveforms to handle the situations of attenuation on single color light or multiple color lights. Further, the DLP projector 400 itself may provide a plurality of projection modes according to different demands of the user, such as a color balance mode or a brightest mode. For the attenuation of the color lights under these projection modes, it is required to provide various energy waveforms so as to find a waveform most suitable for color compensation.

All of aforesaid factors may affect a final result of color compensation, such that the design of the energy waveforms provided for the DLP projector 400 is required to consider various situations, so as to make the projection frames of the DLP projector 400 have best color compensation result. Accordingly, the present invention stores a plurality of energy waveforms on the storage unit 408 of the DLP projector 400 in advance for handling the requirements of various situations. Embodiments are respectively provided hereinafter according to aforesaid situations, so as to elaborate the steps of the color compensation method of the present invention.

Regarding the situation of determining the direct light and the reflection light, since a difference between the strength of the direct light and the strength of the reflection light is large, the present invention sets a threshold between the direct light and the reflection light and uses the same as the basis to determine the direct light and the reflection light.

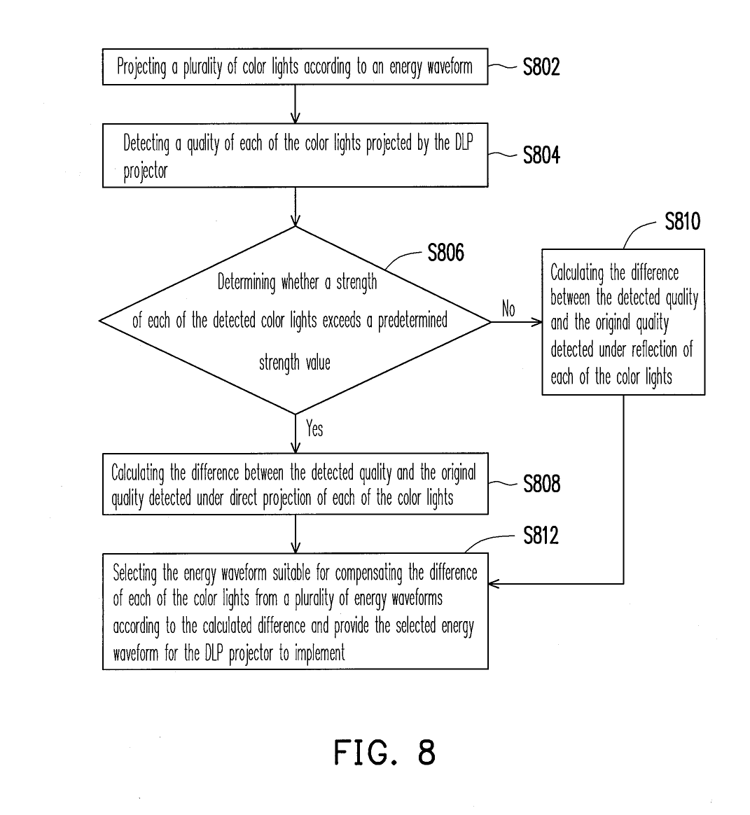

FIG. 8 is a flowchart illustrating a color compensating method of a projector bulb according to an embodiment of the present invention. Referring to FIG. 4 and FIG. 8, the color compensating method of the present embodiment is different from that of FIG. 7 on that, after the quality of each of the color lights is detected, the present embodiment further determines the detected color light is a direct light or a reflection light and accordingly selects suitable quality parameters to compare with the detected quality of the color lights. The detail steps are as follows.

First, the projecting unit 102 projects a plurality of color lights according to the energy waveform (step S802). Next, the sensing unit 104 detects a quality of each of the color lights projected by the DLP projector 400 (step S804).

The comparison module 404 further determines whether a strength of each of the color lights detected by the sensing unit 104 exceeds a predetermined strength value (step S806). If the strength of the color light detected by the sensing unit 104 exceeds the predetermined strength value, the comparison module 404 determines the color light as a direct light directly projected by the DLP projector 400 and then the calculation module 402 calculates the difference between the quality detected by the sensing unit 104 and the original quality detected under direct projection of each of the color lights (step S808). If the strength of the color light detected by the sensing unit 104 does not exceed the predetermined strength value, the comparison module 404 determines the color light as a reflection light reflected by the DLP projector 400 and then the calculation module 402 calculates the difference between the quality detected by the sensing unit 104 and the original quality detected under reflection of each of the color lights (step S810). Finally, the adjustment module 406 selects the energy waveform suitable for compensating the difference of each of the color lights from the plurality of energy waveforms stored in the storage unit 408 according to the calculated difference and provides the selected energy waveform for the DLP projector 400 to implement (step S812).

Regarding the situation of compensating different color lights, since the attenuation of the color lights resulting from the aging of the bulb 110 may not be only one color, it is required to store a plurality of energy waveforms in the storage unit 408, so as to provide for the DLP projector 400 to implement under various situations of color light attenuation. The present invention finds out the kinds and the number of color lights that easily attenuated due to the aging of the bulb 110, so as to respectively design energy waveforms for handling aforesaid situations of color light attenuation.

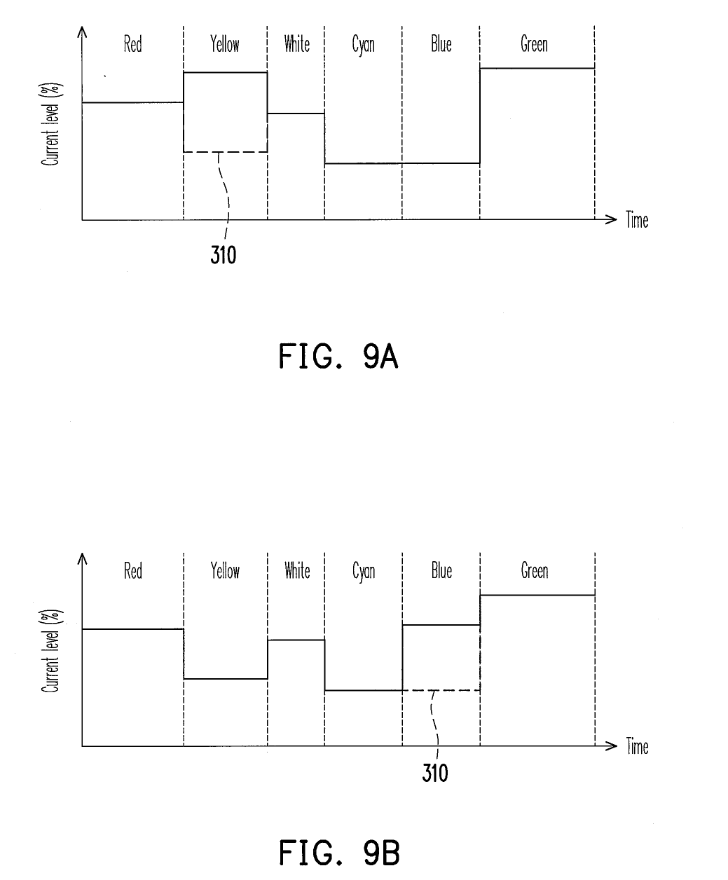

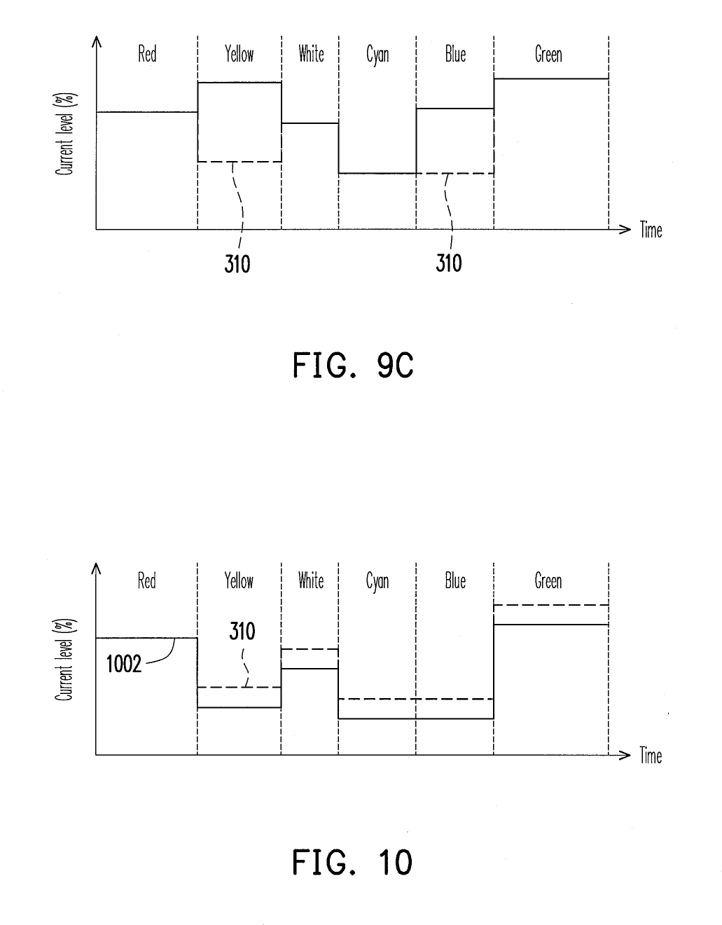

For example, FIG. 9 is a schematic diagram of an energy waveform according to an embodiment of the present invention. Referring to FIG. 3 and FIGS. 9A to 9C, the present embodiment uses the energy waveform of FIG. 3 as an original energy waveform of the DLP projector 400. FIGS. 9A to 9C are waveforms respectively designed to the situations of yellow light attenuation, blue light attenuation, and both yellow light and blue light attenuation. If the sensing unit 104 detects that the quality of the yellow light projected by the DLP projector 400 attenuates, adjustment module 406 selects the energy waveform of FIG. 9A and then provides the same for the DLP projector 400 to implement, so as to achieve color compensation on yellow light. Similarly, if the sensing unit 104 detects that the quality of blue light attenuates, the adjustment module 406 selects the energy waveform of FIG. 9B and then provides the same for the DLP projector 400 to implement, so as to achieve color compensation on blue light. If the sensing unit 104 detects that the quality of both yellow light and blue light attenuate, the adjustment module 406 selects the energy waveform of FIG. 9C and then provides the same for the DLP projector 400 to implement, so as to achieve color compensation on both yellow light and blue light.

Regarding situations of various projection modes, the DLP projector 400 may comprise a plurality of projection modes such as a color balance mode, a brightest mode and a power saving mode. Regarding each of the projection modes, the present invention provides various different energy waveforms to enable the DLP projector 400 to implement suitable energy waveform according to different situations of color light attenuation under different projection modes.

For example, in the color balance mode, the present invention provides energy waveforms similar to the energy waveforms of FIGS. 9A to 9C to enable the DLP projector 400 to implement suitable energy waveform according to the situations of attenuation on each of the color lights under the color balance mode, so as to achieve color compensation and color balance restoration.

It is noted herein that since the original waveform under the brightest mode has set the energy of each of the color lights in a highest state that can be received, when the bulb 110 is aging, the attenuated color light of the bulb 110 is not able to be compensated through increasing the energy provided for the bulb 110. At this time, it can only reduce the energy of other color lights to restore the color balance of the projection frames of the DLP projector 400.

For example, FIG. 10 is a schematic diagram of an energy waveform according to an embodiment of the present invention. Referring to FIG. 4 and FIG. 10, the present embodiment uses the energy waveform of FIG. 4 as an original energy waveform of the DLP projector 400 under the brightest mode, in which the energy waveform depicts the most energy (i.e. current level) that can be provided for the bulb 110 when the DLP projector 400 projects each of the color lights. When the quality of red light projected by the DLP projector 400 attenuates, since the current level of the red light cannot be increased, only the energy waveform 1002 as drawn in FIG. 10 can be selected as the energy waveform provided for the bulb 100 to implement. Through the attenuation of current level of the color lights other than the red light, the projection frames of the DLP projector 400 can resume the color balance.

To sum up, the present invention detects and analyzes the color lights projected by the DLP projector, and accordingly adjusts the energy waveform provided for the DLP projector, such that color compensation on each of the color lights can be achieved. The present invention also performs detection on different color lights by projecting test frames with different colors. Therefore, in the adjustment process of energy waveform, the present invention is able to select the energy waveform most suitable for compensating current attenuation of each of the color lights from a plurality of predetermined energy waveforms according to the attenuation of each of the color lights under each of the projection modes and provides the selected energy waveform for the DLP projector to implement, such that optimization of color compensation can be achieved without affecting color balance.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A color compensation method of a projector bulb, suitable for a DLP projector having a bulb and a color wheel, the method comprising:
projecting a plurality of color lights according to an energy waveform, wherein the energy waveform defines an energy provided for the bulb when the DLP projector projects each of the color lights;
detecting a quality of each of the color lights projected by the DLP projector; and
calculating a difference between the detected quality and an original quality of each of the color lights, so as to adjust the energy waveform and compensate the difference of each of the color lights.

2. The color compensation method as recited in claim 1, wherein the step of detecting the quality of each of the color lights projected by the DLP projector comprises:
detecting the quality of the light projected through the color wheel when the color wheel is rotated to a color and using the detected quality as the quality of the color light corresponding to the color.

3. The color compensation method as recited in claim 1, wherein the step of calculating the difference between the detected quality and the original quality of each of the color lights, so as to adjust the energy waveform and compensate the difference of each of the color lights comprises:
adjusting the energy provided for the bulb when projecting each of the color lights defined in the energy waveform according to the difference between the quality and the original quality of each of the color lights, so as to compensate the difference of each of the color lights.

4. The color compensation method as recited in claim 1, wherein the step of calculating the difference between the detected quality and the original quality of each of the color lights, so as to adjust the energy waveform and compensate the difference of each of the color lights comprises:
respectively calculating the difference between the detected quality and the original quality of each of the color lights;
determining whether the difference exceeds a threshold; and
adjusting the energy provided for the bulb when projecting the corresponding color light defined in the energy waveform when the difference exceeds the threshold, so as to compensate the difference resulting from the attenuation of corresponding color light.

5. A color compensation method of a projector bulb, suitable for a DLP projector having a bulb and a color wheel, the method comprising:
projecting at least one test frame according to an energy waveform, wherein the energy waveform defines an energy provided for the bulb when the DLP projector projects one of a plurality of color lights;
detecting a quality of each of the color lights projected by the DLP projector; and
calculating a difference between the detected quality and an original quality of each of the color lights, so as to adjust the energy waveform and compensate the difference of each of the color lights.

6. The color compensation method as recited in claim 5, wherein the steps of projecting at least one test frame according to the energy waveform and detecting the quality of each of the color lights projected by the DLP projector comprise:
projecting a plurality of test frames with different colors according to the energy waveform; and
detecting the quality of a light projected through the color wheel by using a photo sensor when the color wheel is rotated to one of a plurality of colors according to an arrangement and a ratio of the colors of the color wheel and using the detected quality as the quality of the color light corresponding to the color, wherein the test frames of the colors comprise red frames, green frames and blue frames.

7. The color compensation method as recited in claim 5, wherein the steps of projecting at least one test frame according to the energy waveform and detecting the quality of each of the color lights projected by the DLP projector comprise:
projecting a white frame according to the energy waveform; and
detecting the quality of each of the color lights projected by the DLP projector.

8. A color compensation method of a projector bulb, suitable for a DLP projector having a bulb and a color wheel, the method comprising:
projecting a plurality of color lights according to an energy waveform, wherein the energy waveform defines an energy provided for the bulb when the DLP projector projects each of the color lights;
detecting a quality of each of the color lights projected by the DLP projector; and
calculating a difference between the detected quality and an original quality of each of the color lights, so as to select the energy waveform suitable for compensating the difference of each of the color lights from a plurality of energy waveforms and provide the selected energy waveform for the DLP projector to implement.

9. The color compensation method as recited in claim 8, wherein after the step of detecting the quality of each of the color lights projected by the DLP projector, the method further comprises:
determining whether a strength of each of the detected color lights exceeds a predetermined strength value;
determining the detected color light as a direct light directly projected by the DLP projector if the strength exceeds the predetermined strength value; and
determining the detected color light as a reflection light reflected from a projection frame of the DLP projector if the strength does not exceed the predetermined strength value.

10. The color compensation method as recited in claim 9, wherein
calculating the difference between the detected quality and the original quality detected under direct projection of each of the color lights when the detected color light is determined as the direct light; and
calculating the difference between the detected quality and the original quality detected under reflection of each of the color lights when the detected color light is determined as the reflection light.

11. The color compensation method as recited in claim 8, further comprising:
providing the energy waveforms with respect to the attenuation of one or more of the color lights projected by the DLP projector, and calculating the difference between the detected quality and the original quality of each of the color lights, so as to select the energy waveform suitable for compensating the difference of each of the color lights from the plurality of energy waveforms and provide the selected energy waveform for the DLP projector to implement.

12. The color compensation method as recited in claim 11, further comprising:
respectively providing at least one corresponding energy waveform for a plurality of projection modes of the DLP projector, wherein the projection modes comprise a color balance mode, a brightest mode or a power saving mode;
calculating the difference between the detected quality and the original quality of each of the color lights when the DLP projector is under the color balance mode, so as to select the energy waveform suitable for increasing the quality of each of the color lights to be the energy waveform of a color balance from the plurality of energy waveforms of the color balance mode and provide the selected energy waveform for the DLP projector to implement; and
calculating the difference between the detected quality and the original quality of each of the color lights when the DLP projector is under the brightest mode, so as to select the energy waveform suitable for decreasing the quality of each of the color lights to be the energy waveform of the color balance from the plurality of energy waveforms of the brightest mode and provide the selected energy waveform for the DLP projector to implement.

13. A DLP projector, comprising:
a projecting unit, comprising:
a bulb, for emitting a light;
a color wheel, for changing a color of the light emitted by the bulb; and
a control module, for controlling an energy provided for the bulb and a color of the color wheel according to an energy waveform, so as to enable the projecting unit to project a plurality of color lights, wherein the energy waveform defines the energy provided for the bulb when the DLP projector projects each of the color lights;
a sensing unit, for detecting a quality of each of the color lights projected by the DLP projector; and
a color compensation unit, for calculating a difference between the detected quality and an original quality of each of the color lights, so as to adjust the energy waveform and compensate the difference of each of the color lights.

14. The DLP projector as claimed in claim 13, further comprising:
an input unit, for inputting image data to the projecting unit for projecting the image data, wherein the control module is a ballaster coupled to the input unit and the bulb, and is for receiving the image data inputted by the input unit and lighting the bulb according to the energy waveform, so as to enable the projecting unit to project a projection frame of the image data.

15. The DLP projector as claimed in claim 13, wherein the color compensation unit comprises:
a calculation module, for respectively calculating the difference between the detected quality and the original quality of each of the color lights;
a comparison module, for determining whether the calculated difference exceeds a threshold; and
an adjustment module, for adjusting the energy provided for the bulb in projecting corresponding color light defined in the energy waveform when the comparison module determines the difference exceeds the threshold, so as to compensate the difference resulting from an attenuation of corresponding color light.

16. The DLP projector as claimed in claim 13, wherein the projecting unit projects a plurality of test frames with different colors according to the energy waveform and the sensing unit is a photo sensor for respectively detecting the quality of a light projected through the color wheel according to an arrangement and a ratio of the colors of the color wheel when the color wheel is rotated to one of the colors, wherein the detected quality is used as the quality of the color light corresponding to the color and the test frames of the colors comprise red frames, green frames and blue frames.

17. The color compensation method as recited in claim 13, wherein the projecting unit projects a white frame according to the energy waveform and the sensing unit is a color sensor for detecting the quality of each of the color lights projected by the DLP projector.

18. The DLP projector as claimed in claim 13, further comprising:
a storage unit, for storing a plurality of energy waveforms provided according to the attenuation of one or more of the color lights projected by the DLP projector, wherein the energy waveforms stored in the storage unit are provided according to a direct light directly projected by the projecting unit and a reflection light reflected by a projection frame of the projecting unit.

19. The DLP projector as claimed in claim 18, wherein the color compensation unit calculates a difference between the quality detected by the sensing unit and an original quality of each of the color lights, so as to select the energy waveform suitable for compensating the difference of each of the light colors from the plurality of energy waveforms stored in the storage unit and provide the selected energy waveform for the projecting unit to implement.

20. The DLP projector as claimed in claim 18, wherein the energy waveforms stored in the storage unit are provided for a plurality of projection modes of the DLP projector, wherein each of the projection modes corresponds to at least one waveform and the projection modes comprise a color balance mode, a brightest mode or a power saving mode, and wherein
the color compensation unit selects the energy waveform suitable for increasing the quality of each of the color lights to be the energy waveform of a color balance from the plurality of energy waveforms of the color balance mode and provide the selected energy waveform for the projecting unit to implement; and
the color compensation unit selects the energy waveform suitable for decreasing the quality of each of the color lights to be the energy waveform of the color balance from the plurality of energy waveforms of the brightest mode according to the calculated difference and provide the selected energy waveform for the projecting unit to implement.
